(19) United States
(12) Patent Application Publication
(10) Pub. No.: US 2002/0037767 A1
(43) Pub. Date: Mar. 28, 2002

(54) Gambling system and method through a computer network

(76) Inventor: Steven Ebin, Riverdale, NY (US)

Correspondence Address: DARBY & DARBY P.C., 805 Third Avenue, New York, NY, 10022, US

(21) Appl. No.: 09/924,006

(22) Filed: Aug. 7, 2001

Related U.S. Application Data
(60) Provisional application No. 60/225,958, filed on Aug. 17, 2000.

(51) Int. Cl. A63F 9/24; G06F 17/00

(52) U.S. Cl. 463/25; 463/42

(57) ABSTRACT

Methods operable through a distributed computer network are disclosed which enable direct game play against remotely situated players, of the same skill, and with payout rules of their choosing. One method enables players to gamble directly with one another. In this method, a host server receives a bet from a machine operated by each player, with each machine being connected to the host server through a distributed network. The received bets are combined into a pot, and a hosted game commences among the set of players that contributed to the pot, by prompting the players at their respective machines for inputs. Inputs are then received at the host server and at least one winner is selected from among the set of players on the basis of the received inputs. The pot is then allocated to the at least one winner in accordance with prescribed rules. Another method enables teams of players to compete directly against each other for money. That method includes the steps of establishing several teams across a distributed network., receiving an ante conveyed from each player's machine and combining the antes from all of the players into a pot. A hosted game is then commenced among the teams by prompting the players of each team at their respective machines for inputs. Inputs are thereafter received at the host server, and at least one winning team is selected from among the teams based on the received inputs. The pot is then allocated to the at least one winning team in accordance with prescribed rules.

### FIELD OF THE INVENTION

The present invention relates to Internet gambling and to closed loop intranet gaming.

### BACKGROUND OF THE INVENTION

A number of Web sites are available through the Internet which permit gambling on sports events, casino games, bingo and live racing. Players may question the odds and the payouts provided by these sites —many of which are based outside of the United States—particularly in view of the fact that a computer server is controlling their luck. Another significant factor which detracts from the online playing experience is a feeling of isolation; because players are remotely distributed around the globe, there is little interactivity and nary a sense that they are playing with other real persons.

Perhaps the greatest drawback of hosted gambling is the odds of winning. Whether in a casino, online, or at a State run horse race, the odds of winning are generally stacked in favor of the house. That is how the house makes money. The average gambler, over time, will lose money. The professional gambler can be spotted by the house and ejected, as is now customary, to protect themselves against great loss.

What is needed in the art and has heretofore not been available is a gambling system that enables remotely situated players to play against each other, with the winner collecting the entire pot, minus perhaps a commission for hosting the session. What is further needed is such a system that enables players to choose their opponent(s). Such a system would be further enhanced by including filters to match a player's skill level with that of his or her potential opponent so that experts generally play against other experts and novices generally play against other novices. The present invention satisfies these and other needs.

### SUMMARY OF THE INVENTION

The present invention provides methods operable through a distributed computer network which provide gaming services to players. In particular, the invention enables direct game play against remotely situated players, of the same skill, and with payout rules of their choosing.

In accordance with one aspect of the invention, a method is provided for enabling players to gamble directly with one another. In this method, a host server receives a bet from a machine operated by each player, with each machine being connected to the host server through a distributed network. The received bets are combined into a pot, and a hosted game commences among the set of players that contributed to the pot, by prompting the players at their respective machines for inputs. Inputs are then received at the host server and at least one winner is selected from among the set of players on the basis of the received inputs. The pot is then allocated to the at least one winner in accordance with prescribed rules.

In another aspect of the invention, a method for enabling teams of players to compete directly against each other for money is described. That method includes the steps of establishing at least a first team and a second team, the teams including non-overlapping sets of players each of which is connected by a machine to a host server through a distributed network. The host server then receives an ante conveyed from each player's machine and combines the antes from all of the players into a pot. A hosted game is then commenced among the teams by prompting the players of each team at their respective machines for inputs. Inputs are thereafter received at the host server, and at least one winning team is selected from among the teams based on the received inputs. The pot is then allocated to the at least one winning team in accordance with prescribed rules.

These and other aspects, features and benefits of the present invention can be better understood with reference to the accompanying Drawings and Detailed Description of the Preferred Embodiment.

### DESCRIPTION OF THE FIGURES

FIG. 1 illustrates a network arrangement that is useful in implementing the preferred embodiment of the invention;

FIG. 2 illustrates a process flow for guiding a player to various gaming events that are being hosted by the host Web server of FIG. 1;

FIG. 3 illustrates an exemplary Web page that has been tailored to display information specific to a particular player;

FIG. 4 illustrates a process flow for an exemplary game of chance being hosted by the host Web server;

FIG. 5 illustrates an exemplary Web page through which a player plays the game of chance;

FIG. 6 illustrates a process flow for guiding a user to a game of skill of the type in which the player answers questions that have been posed by the host Web server;

FIG. 7 illustrates an exemplary Web page through which a player selects a game of skill;

FIG. 8 illustrates an exemplary Web page through which a player selects payout rules and bet sizes;

FIG. 9 illustrates an exemplary Web page through which a player plays a selected game of skill; and

FIG. 10 illustrates a process flow for guiding a user to an exemplary, hybrid game of the type involving both luck and skill.

### DETAILED DESCRIPTION OF THE PREFERRED EMBODIMENT

By way of overview and introduction, the present invention provides a system and method for providing gaming services to players through a distributed network such as the Internet. As a departure from other gaming services, the present invention permits direct play and even challenges among persons who have access to the host server 110. The games can be two players or multi-players, with the pot being shared in accordance with prescribed rules, as described in detailed below.

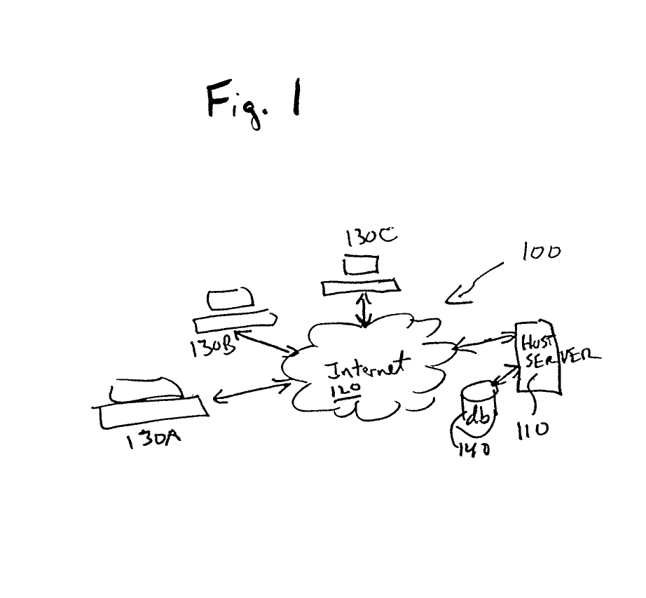

With reference to FIG. 1, a network arrangement for implementing a method in accordance with the present invention is described. The network 100 includes a host server 110 which provides content over the Internet 120 to a plurality of distributed users that access the host server 110 through client stations or machines 130A, 130B, 130C, . . . , more generally referred to as client machines 130. The content provided by the host server 110 can be viewed by users through a Web browser or other functionally equivalent software running at their respective client machines 130 and data can be exchanged in a conventional manner between the host server 110 and the client machines 130. The client machines 130 can assume a variety of forms, including devices which can be made compatible with standard protocols for information exchange through the Internet such as a home computer, an Internet appliance, a television equipped or provided with outboard devices to support interactive communications (e.g., through a cable television set top box or a satellite signal receiver), a personal digital assistant, an Internet compliant telephone (e.g., a 3G mobile device), or other Internet compliant communications device.

In the present invention, the host server 110 is configured to host gaming services and to process electronic commerce transactions that transpire between particular users at client machines 130. The host server 110 can support other types of electronic commerce transactions to provide goods, other services, or both to users that access it. As described below, each user is identified by the host server and data concerning such users including their preferences, prior performance, buddy lists, and transaction history, are preferably maintained by a database 140 which is in operative communication with the host server. The host server 110 and the plural client machines 130 are configured to communicate with one another in a conventional manner over a communication link established by way of the Internet 120. In lieu of the Internet, communications can be through an Intranet or Extranet, as understood by those of skill in the art.

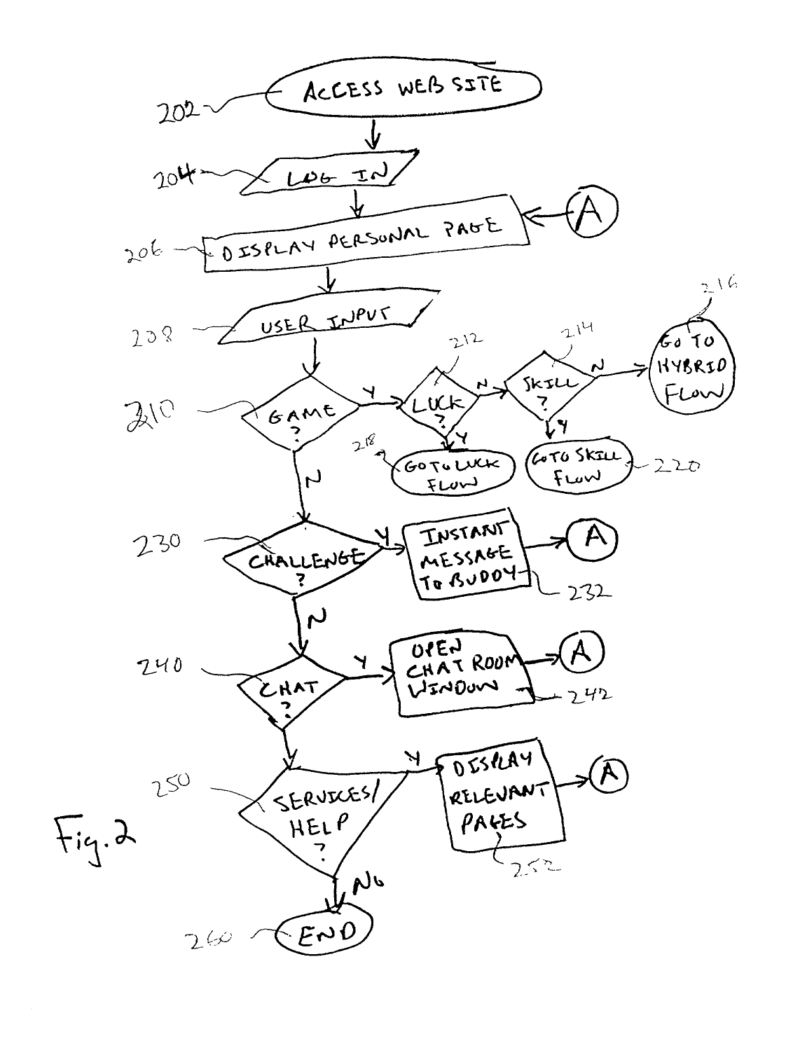

FIG. 2 illustrates a main process flow by which players who access the host server 110 can select various gaming events and services being offered by the host server. At step 202, the user accesses a website hosted by the host server 110 from a client machine 130 in any conventional manner. Upon accessing the website, the user logs in to the host server by providing a screen name or the like, as indicated at step 204. Preferably, the user also provides a password which restricts unauthorized persons from playing under the user's name.

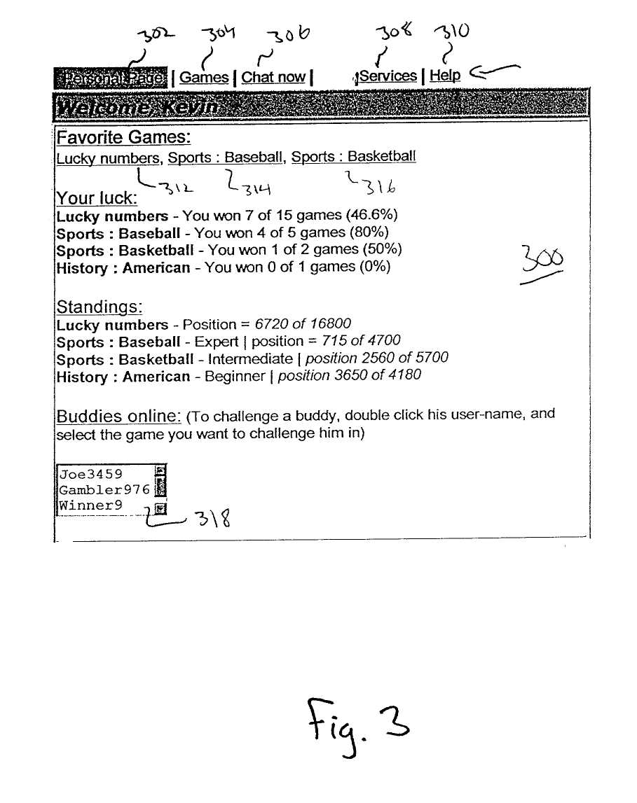

In lieu of a manual login process as at step 204, access can be permitted automatically if the client machine 130 provides to the host server 130 a cookie or its equivalent upon accessing the website. In that case, the cookie can be used to identify the user and automatically log that user as a player onto the website. However, regardless of how the login process is accomplished, a personal page 300 is preferably is displayed at step 206 (see FIG. 3). The personal page 300 is preferably constructed dynamically using information in the database 140 concerning that user. For example, the personal page can be constructed using DHTML to provide links to the user's favorite games, statistical information on the user's luck and standings in various games that he or she has played. In addition, the personal page 300 can include a selection list of buddies that are presently logged onto the host server 110. In a conventional manner, a user can add or delete buddies from a personal (buddy) list of subscribers. The personal page further can provide accounting information to the user including any credit or debit transactions concerning the player's account. As can be appreciated, all bets made by players must be preceded by an authorization to charge the player's account, and payouts are made to a player's account, whether an account maintained by the host server 110, or a third party account (e.g., the bank that maintains the account that is charged to cover the bet).

An exemplary personal page is illustrated in FIG. 3. FIG. 3 includes text as well as links to other pages maintained by the host server 110. For example, a selection of buttons 302-310 can be provided to assist the player in navigating to various pages maintained by the host server 110, a series of hypertext links 312-316 can be provided to navigate the player to favorite games that he or she has previously played, and a selection box 318 can be provided to enable the player to challenge one or more other buddies in that user's buddy list.

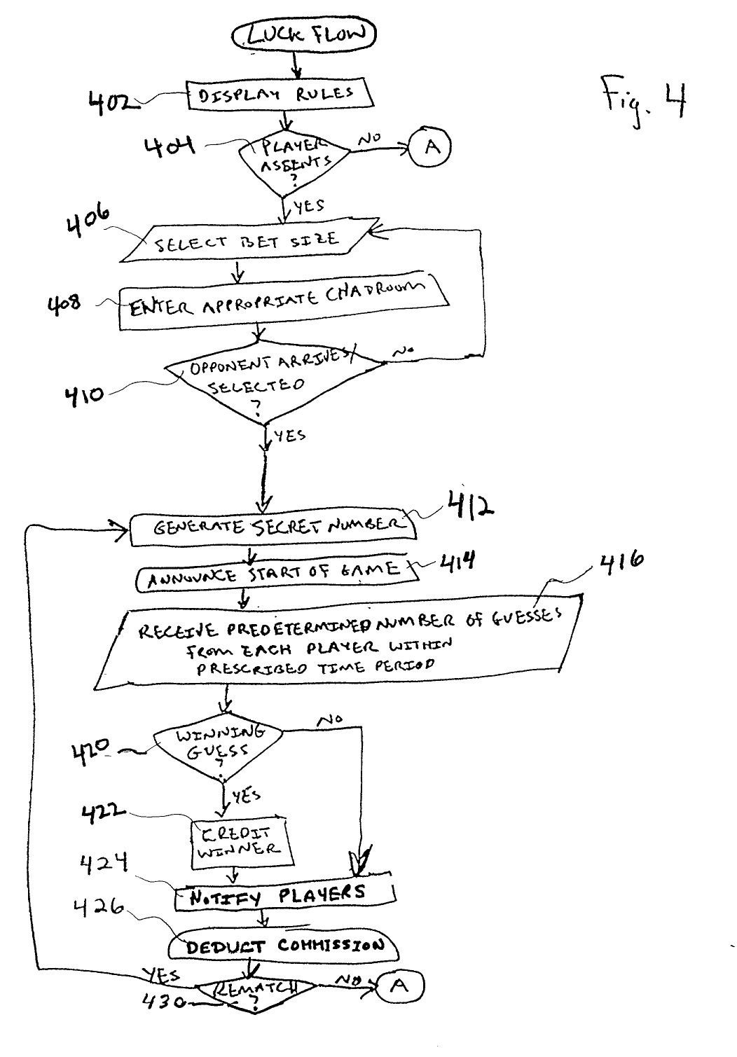

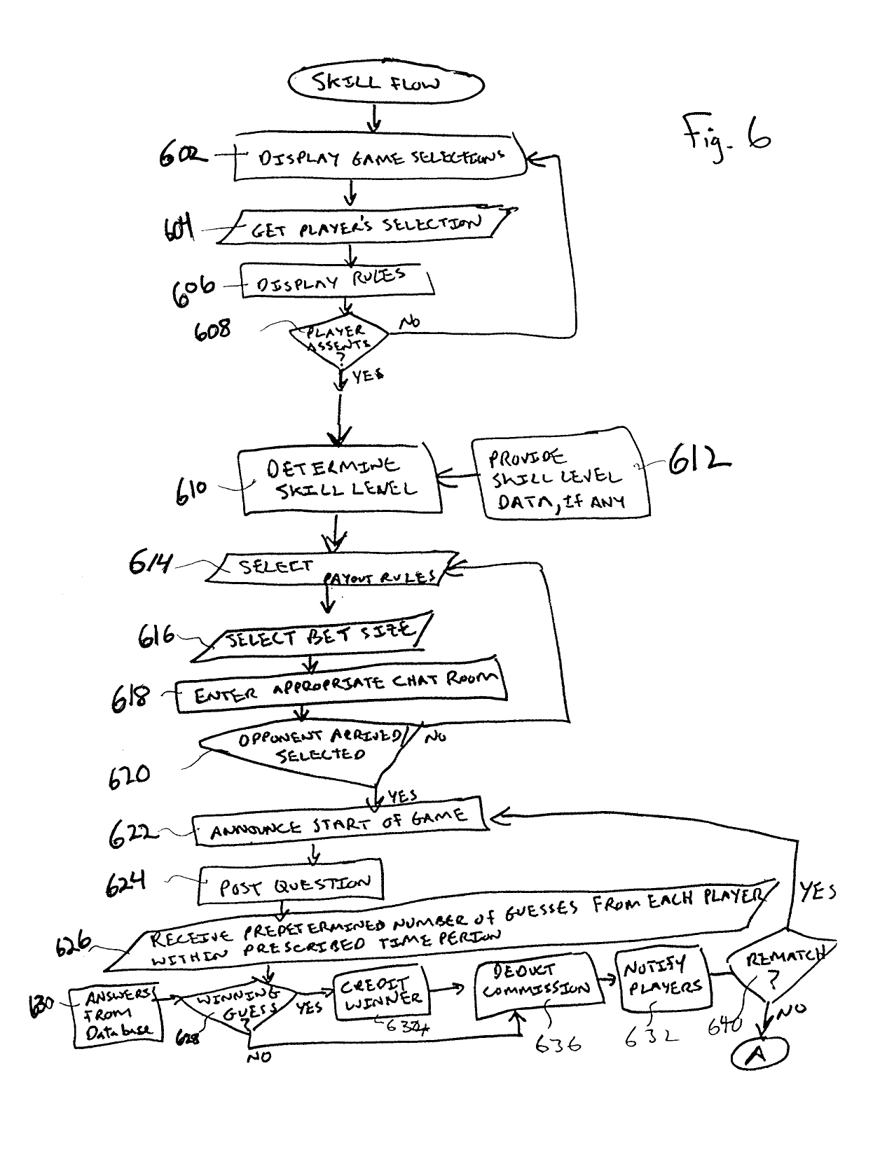

Referring back to FIG. 2, the user selects one of the options made available from the web page 300 at step 208 by providing an input. The input can be a selection using a selector (e.g., a mouse, joystick, or a keyboard) or other input device. Depending on the input from the user, the process flow continues in a prescribed manner until the user is again returned to the personal page 300. If the user selects a game, as tested at step 210, then the process flow proceeds to a particular game type such as a game which is based purely on luck, as tested at step 212, to a game based purely on skill as tested at step 214, or to a game which is based on both luck and skill, as indicated at step 216. If the selection game is one base on luck, such as the pick a number game described below in connection with FIG. 4, then the process flow proceeds to the luck flow diagram of FIG. 4, as indicated at step 218. If the game selection is a skill game such as baseball trivia, then the process flow proceeds to the skill flow diagram of FIG. 6, as indicated at step 220.

On the other hand, if the user has selected to challenge a buddy in his or her buddy list 318, as tested at step 230, then the host server will send an instant message to the selected buddy apprizing him of the challenge by the first user, as indicated at step 232. For example, if one user accesses the host server through client machine 130A, and has in his or her buddy list user “Joe3459” who is online and also accessing the host server through a client machine 130C, then upon the first user's selecting Joe3459 from the buddy list 318 using a selector device, the host server causes an instant message to be sent directly to client machine 130C apprizing that user (“Joe3459”) of the challenge by the user at client machine 130A (e.g., Kevin, whose personal page 300 is shown in FIG. 3).

If the user has selected to chat with other users by pressing the chat button 306, as tested at step 240, then the user is navigated to a chat room and has a chat room window displayed, as indicated at step 242, at his or her client machine 130.

The user can select other services, help or features provided by the host server through the personal page 300, as tested at step 250, and relevant pages and content can be provided to the user if such information has been requested, as indicated at step 252. Preferably, regardless of the input provided by the user at step 208, once a selected activity is complete, the user is returned to the personal page 300, as indicated by the various links back to A in the flow diagram of FIG. 2. The process ends at step 260 when the user terminates his or her session with the host server 110.

Referring now to FIG. 4, a process flow for a game of chance is described. The process flow FIG. 4 is invoked when the user selects a game of chance, as tested at step 212, and commences at step 218. The game of FIG. 4 is a simple “pick a number between 1 and 10” game. Other games that can be won purely on the basis of chance can be implemented in accordance with the present invention; the pick a number game of FIG. 4 is merely exemplary of one type of game of chance. What is important to the present invention is that players be able to compete against one another, rather than the “house.”

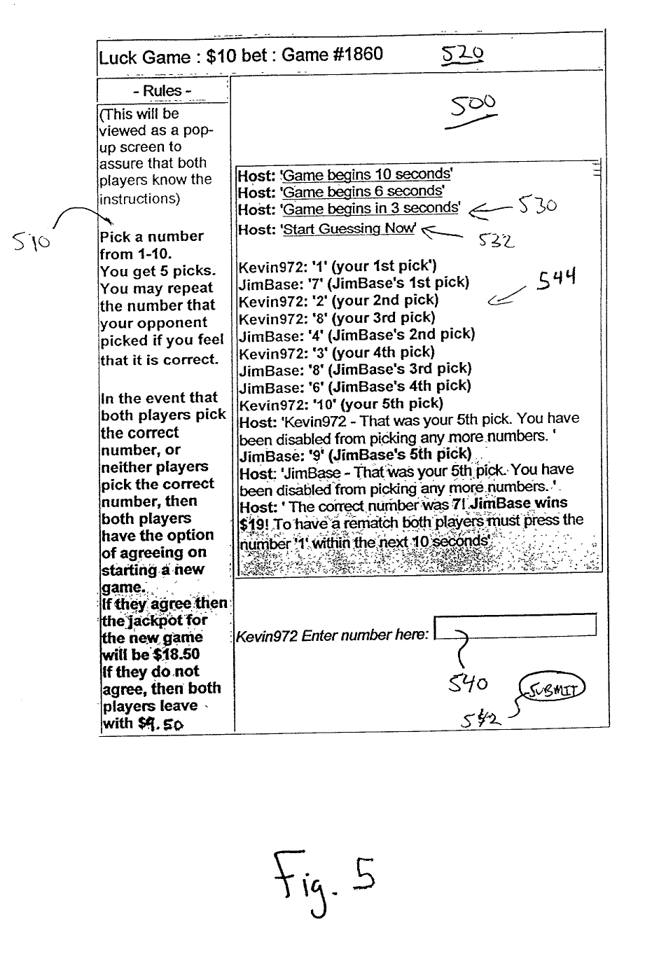

The pick a number game is now described in connection with FIGS. 4 and 5. At step 402, the rules of the pick a number game are displayed to a player at a particular client machine 130. The rules are preferably displayed in a portion 510 of an active window 500, in which the luck game proceeds. If the player does not assent to the rules, as tested at step 404, then he or she is returned to the personal web page 300. If the player assents to the rules, then he or she selects and enters a bet size at step 406. The luck game window 500 indicates in a title bar 520 that the player has selected a $10 bet, game number 1860. Through the course of the day, week, etc., games are repeatedly played and assigned successive game numbers. At any given time, there are games proceeding at various bet sizes. Upon selecting a given bet size, at step 406, the user is brought to an appropriate chat room, as at step 408, which causes a window such as the window 500 to be displayed. In the luck game of FIGS. 4 and 5, two players have entered the chat room and have been provided with the active luck game window 500. However, until a second or further opponent arrives or is selected (e.g., by selecting one or more buddies from the buddy list 318 of FIG. 3), the game will not start. If after a prescribed period of time an opponent does not arrive or is not selected by the player, as tested at step 410, then the player is given the opportunity to select a different bet size for the same game and thereafter enter another chat room which includes at least one other player who is ready to play the luck game. To maximize player satisfaction, upon or prior to selecting the bet size at step 406, the player is preferably provided with information as to the number of other players who are presently in the chat room for each size bet.

Once a suitable number of players (e.g., two players) has entered the chat room and has the luck game window 500 on each one's respective display, a game countdown timer 530 begins. The game countdown timer indicates the amount of time until the players are permitted to start guessing, which in this exemplary game comprises picking numbers between 1 and 10. At step 412, the host server generates a number which is maintained in secret, that is, it is not disclosed to either of the opponents in the chat room 500. The game start time is announced at step 414, as indicated at 532 in the active window. A predetermined number of guesses are received at the host server based on inputs received from the client machines of the respective players/opponents. The players input a predetermined number of guesses into a text box 540 and submit their guesses using a submit button 542. These guesses are received from each player within the prescribed period of time, as indicated at step 416. In the luck game of FIG. 5, each player is permitted to enter 5 number picks. Once the prescribed number of guesses have been received, or the prescribed time period has expired, if there is any such time period, the host server 110 determines whether there was a winning guess, at step 420.

The five picks by the two players are illustrated in the window 500 at locations 544.

In the event that there is a winner, the winner is credited at step 422 with the amount of the pot (which includes the bets from each of the players). In the example of FIG. 5, two players (Kevin972 and JimBase) each bet $10 to create a pot of $20. As illustrated in FIG. 5, the correct number between 1 and 10 was 7, which number was picked by JimBase. The players are notified that JimBase is the winner, at step 424, and the host server optionally deducts a commission for hosting the game at step 426. For example, a commission of 0.50 cents can be exacted from each of the players for participating in the game. A commission need not be charged, however, because, the host server can fund the games from other sources such as advertising, affiliate programs, co-marketing efforts and the like. The host server prompts the players to see whether they wish to have a rematch, for example, by requesting that each of the players provide a specific input into the box 540 and submit their answer within a prescribed period of time. If both players have indicated that they wish to have a rematch, as tested at step 430, then another number is generated at step 412 and a subsequent game is announced at step 414. The game proceeds as described above, with each of the players submitting a predetermined number of guesses, a test being made to determine whether one is the winner, and a commission being deducted, if a commission is to be charged at all.

The rules can provide for situations in which both players pick the correct number or in which neither player picks the correct number. In those situations, the pot for the new game can be carried forward from the last game, with a further commission optionally being deducted for hosting the replay. With each successive replay, the commission for the house can get larger and the amount of the pot gets smaller. On the other hand, if the players do not wish to rematch, each is cashed out in the amount of his or her share of the pot that remains after deducting the host server's commission, if any. In that event, in which the players decline the rematch, each player is returned to their respective personal page 300, for further input at step 208 as described above in connection with FIG. 2.

Referring now to FIG. 6, a process flow for a game of skill is described. The process flow of FIG. 6 is invoked when the user selects a game of skill, as tested at step 214, and commences at step 220. The game of FIG. 6 is a simple trivia game in which the player must respond to at least one question posed by the host server 110 (and optionally selected by the opponent player). Other games that can be won on the basis of skill can be implemented in accordance with the present invention; the trivia game of FIG. 6 is merely exemplary of one type of game of skill. As with the luck games, what is important to the present invention is that players are enabled to compete against one another, rather than the “house.”

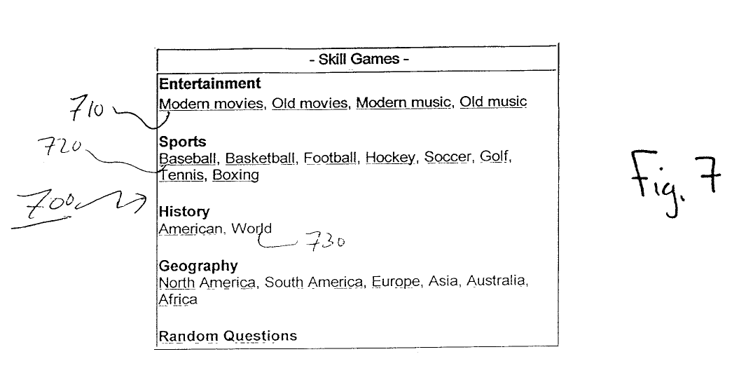

A skill game is now described in connection with baseball trivia with reference to FIGS. 6-9. At step 602, various skill games are presented to the user in a skill game selection window 700. The skill game selection window includes selections of games, for example, in the form of hypertext links 710, 720, 730, etc., any one of which can be selected in a category of interest to the user. Exemplary categories are illustrated in FIG. 7.

At step 604, the user's selection is obtained in response to the user interacting with a selector or other input device, as described previously. The rules for the selected game, as well as the bet sizes that are available and, optionally, the number of opponents that are online and interested in playing that type of game are all displayed in a game window 800.

A title bar 820 identifies the particular skill game 810 selected by the user (e.g., “sports: baseball,” as shown, and the skill level 815 of the game, if already known for that player. The rules are displayed, at least initially, in region 830. The player can accept these rules by pressing the “rules ok” button 840, or can select his or her own payout rules using the button 850. The type of payout rules that the player can select prescribe the payout that will be had once the game has been played.

The player must assent to the rules for a given game, as tested at step 608, or else different game selections will be presented to the player (step 602). Prior to playing the selected game, that player's skill level is determined at step 610. The player's skill level can be determined at any time prior to playing the game. The skill level “determination” includes retrieving skill level data for that player from a data store, as indicated at step 612.

A player's skill level is used to better ensure that players are competing against other players of a similar skill level, or to apprize a player that he or she is competing with a more skilled opponent. The skill level can be determined in a variety of ways. One way to determine a player's skill level is to quiz the player with a series of (one or more) questions concerning the selected category and to then rank the player's skill on the basis of the number or percentage of correct/incorrect answers. A more reliable basis for ranking the skill level of the player uses past performance data of the player in that game. If the player consistently wins (e.g. 5 times in a row), then the player's skill level may be advanced. Likewise, a player's skill level can be reevaluated and lowered in the event that the player loses consistently. Because winning and losing are directly associated with financial gain and loss, this ranking methodology can be quite reliable. Of course, a combination of these and other approaches may be utilized to determine a player's rank.

At step 614, the player selects payout rules, for example, using buttons 840, 850. Further payout rule selections are required if button 850 is pressed, for example, by interacting with questions or checklists, etc. presented on another page or in another window or frame (not shown). The payout rules can vary.

Preferably, there are prescribed rules for pot sharing. The rules can be prescribed by the host server, and players can be given the opportunity to mutually select a set of rules to govern a given game. For two player games, the pot sharing rules can be simply that the winner takes all, subject to any commission that is payable to the host. With that rule in place, the odds of winning are 50:50. There can be additional rules, however, which are invoked in certain circumstances. For example, in the event of a tie, the players can be required to ante again and have a rematch prior to the pot being awarded. The failure of a player to ante further can result in the pot being awarded to the other player, or to the host.

In multi-player games, the rules for pot sharing can be prescribed in a variety of ways. For example, one set of prescribed rules awards 60% of the pot to the 1^{st} place winner, 25% of the pot to the 2^{nd} place winner and 15% of the pot to the 3^{rd} place winner, all subject to any commission that is payable to the host. Another set of rules can be 1^{st} place winner takes all (i.e., 100% of the pot, subject to any host's commission). Still another set of rules can be that the pot is held for a rematch in the event of a 1^{st} place tie, or that a rematch is run as between two tied players to determine which will be awarded a percentage of the pot. The rules also can be configured to require further antes by the players from game to game until a pot is awarded. Once the payout rules are selected, the rule 830 need no longer be displayed.

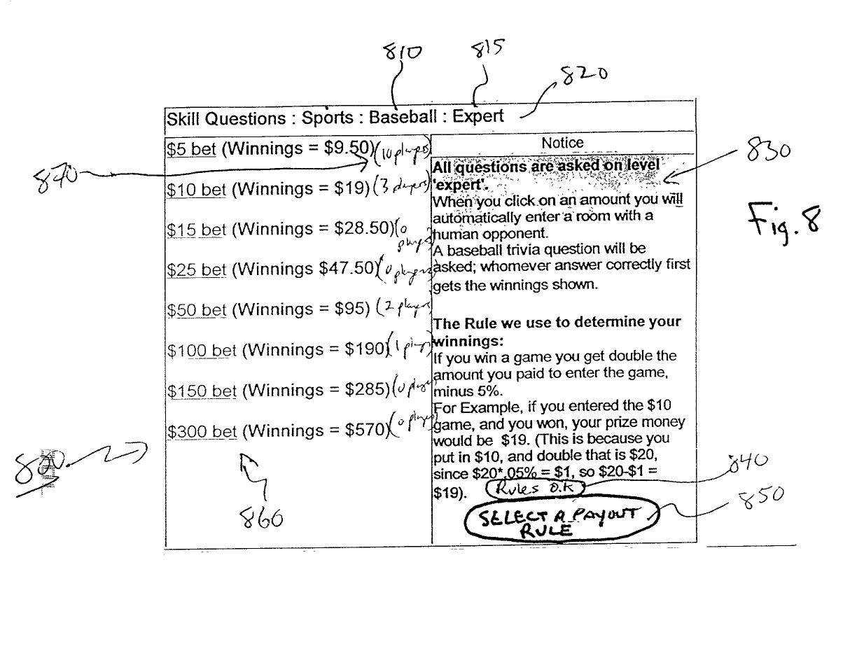

At step 616, the bet size is selected using one of the hypertext links in region 860 of the selected game window. Equivalently, bet size can be selected using buttons, key presses, and the like; FIG. 8 is merely an exemplary selected game window. Once a bet size is selected, the user has committed a bet which is that user/player's ante into the pot.

Preferably, there is a chat room for each skill game at each skill level and each bet size. The player having selected each of these parameters, can enter the corresponding chat room at step 618. Preferably, an opponent must arrive or be selected from the buddy list 318 within a predetermined period of time or else the player will be required to select a different bet size (at step 614). To facilitate game play, the selected game window 800 can display the number of players 870 on line who have indicated a desire to play that game, at that skill level, for a given bet size. This information helps each new visitor to the selected game to find an opponent.

If an opponent has arrived, as tested at step 620, then a game start is announced at step 622.

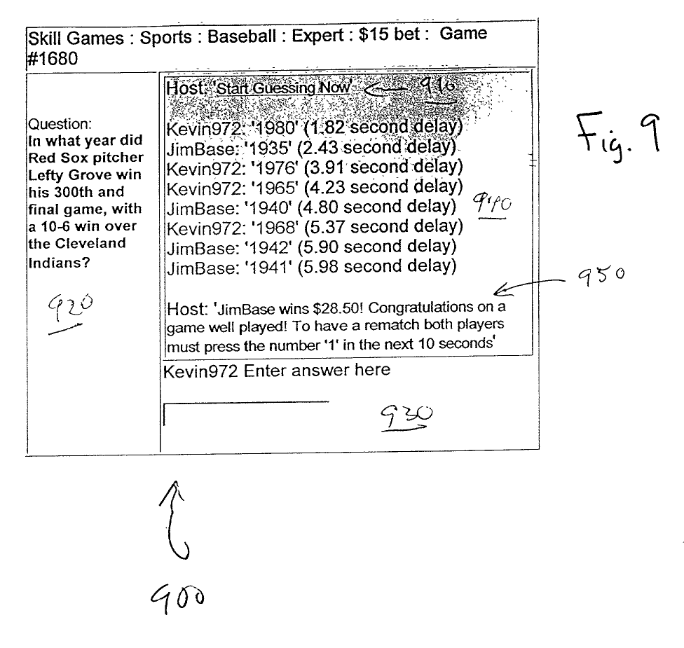

FIG. 9 illustrates a particular game (game number 1680) at a selected bet size ($15.00). The host server announces the start of the game, as indicated in a game play window 900 at 910. The game play window 900 is preferably divided into several regions including a question region 920, an answer region 930, and a progress region 940. The question region 920 displays the trivia question that players race to answer. The question can be in the form of formatted text (e.g., HTML presented in a frame) or a graphic image (e.g., an image file loaded into the window 900). The answer region 930 includes a text box or other construct which is configured to receive input from the player and convey the input answer to the host server 110. The progress region 940 reports the answers received from competing players as well as statistical information such as how long it took to receive each answer. The results of the game can be reported anywhere, but preferably are included in the window 900, for example, at location 950 of the game play window.

Referring now to FIGS. 6 and 9 in particular, a question is posted by the host server 110 to the competing players, as indicated at step 624 and illustrated in the question region 920. After the host has apprized the players to start guessing, a predetermined number of answer guesses are received from each player within a prescribed time period, as indicated at step 626 and illustrated in the answer region 940. Each answer is provided by a player by submitting an answer using the answer region 930 input field. Answer guesses are received from each player within the prescribed period of time, for example five guesses per player. Once the prescribed number of guesses has been received, or the prescribed time period has expired, if there is any such time period, the host server 110 determines whether a winning answer was submitted, at step 628.

The determination of whether one of the answers is a winner is made with reference to a database of answers, as indicated at step 630. In the event that there is a winner, the winner is announced at location 950 of the game play window 900, with all players thereby being notified of the results at step 632. The winner is credited, as indicated at step 632, in the amount of the pot (e.g., $28.50, as shown), and the host server can deduct a commission for hosting the game at step 636. For example, a commission of 0.75 cents can be exacted from each of the players for participation in the game. A commission need not be charged, as noted above, because the host server can fund the games from other sources such as advertising, affiliate programs, co-marketing efforts and the like. In the event that there is no winner, then the process flow proceeds from the test at step 628, as described above, except that no player is credited with the pot.

The host server prompts the players to see whether they wish to have a rematch, for example, by requesting that each of the players provide a specific input into the answer region 930 and submit their answer within a prescribed period of time. If both players have indicated that they wish to have a rematch, as tested at step 640, then the start of the next game is announced at step 622. The game proceeds as described above, with each of the players submitting a predetermined number of answer guesses, a test being made to determine whether there are any winners, and a commission being deducted, if a commission is being charged.

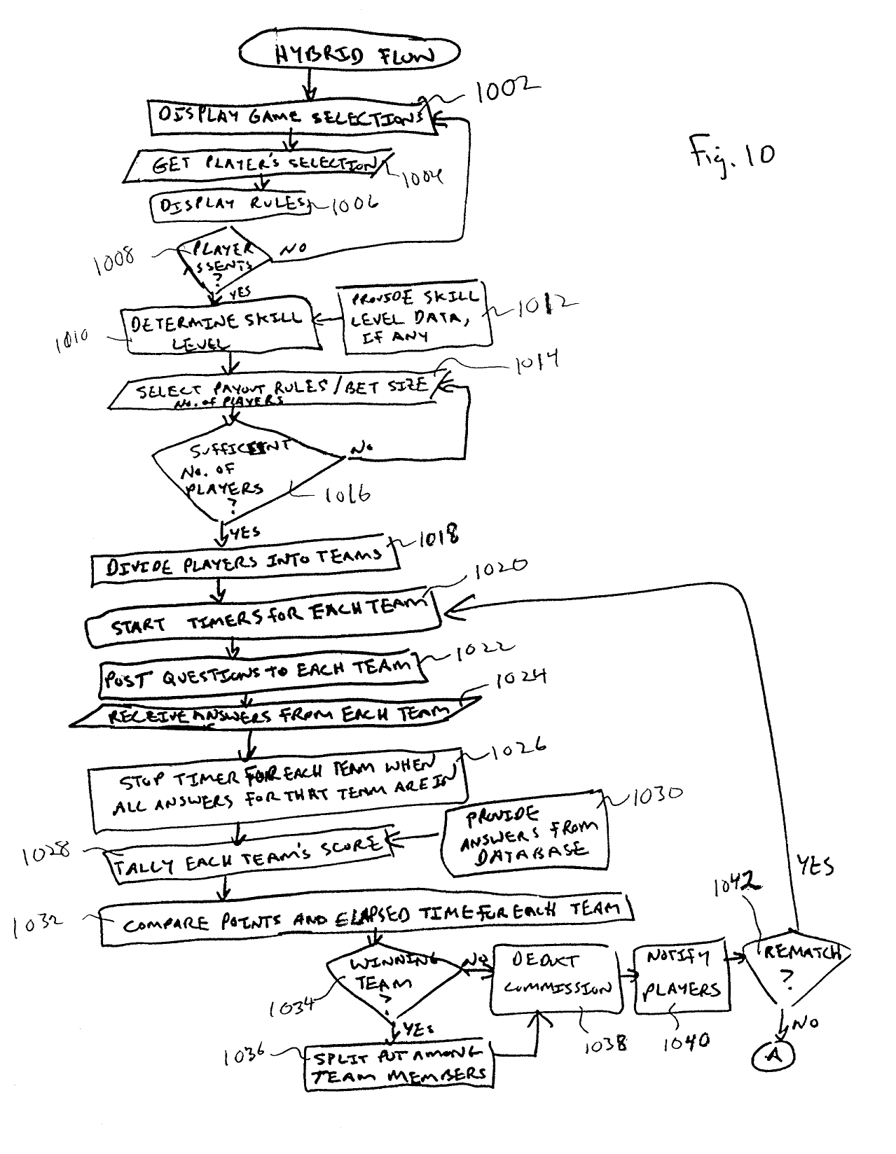

With reference now to FIG. 10, a process flow for a game which combines both luck and skill is described. The process flow FIG. 10 can be invoked by default when the user has selected a game other than one of chance or skill, as a result of the tests at steps 212 and 214. This “hybrid” game commences at step 216. The game of FIG. 10 is very similar to the skill game described in connection with FIGS. 6-9, except now a team of players competes against another team of players, and so while the skill of the individual team members comes to bear on the likelihood of a team winning, the members of the team can be assembled or defined randomly, so as to impart a variable component which does exist when the game play is one-on-on one. Multi-player team games such as in FIG. 10 permit more elaborate pot sharing rules, as described above.

As shown in FIG. 10, various game selections are presented, a selection is made by the user, and rules are presented to the user, with the server awaiting the user's assent to those rules, as shown at steps 1002-1008. Steps 1002-1008 are as described above in connection with steps 602-608. Also, the player's skill level, bet size selections and payout rules are obtained, as shown at steps 1010-1014, as described above in connection with steps 610-616. At this point in time, the user has committed a bet which is that user/player's ante into the pot.

At step 1016, a test is made to determine whether a sufficient number of players has expressed an interest in playing the same game (at the bet size and with the same payout rules) as was selected by the user that just performed the steps 1002-1014. If there is not a sufficient number of such players, the user is given the opportunity to select a different bet size or set of payout rules, or to wait until more players arrive, at least for a prescribed time period. On the other hand, if there is a sufficient number of such players, then the players either divide themselves into teams or the host server 110 divides the players into teams (e.g., team A verses team B), at step 1018. Any given player will be on only one team so that the teams include non-overlapping sets of players. A timer is then started for each time, at step 1020, and questions are posted on the team members respective client machines 130 at step 1022 and answers are received from the team members at step 1024. Various protocols can be selected or imposed concerning which team member can respond to a question (e.g., they have a prescribed line up, or each team member can only answer once) and whether the team is bound by the first response received from any member of a given team.

The game play proceeds as answers from each team are received, until the timer is stopped. For example, separate timers for each team continue to run until the last answer required from a given team is received, as shown in the illustrative flow diagram of FIG. 10 at step 1026. At the conclusion of a game, each team's score is tallied, at step 1028, with regard to answers provided from an answer database 1030. At step 1032, the points garnered by each team are compared, in light of the time that elapsed in obtaining the responses, and a test is made at step 1034 to determine whether any team is a winner. If there is a winner, then at step 1036, the pot is split among the team members. Regardless of whether there were any winners, a commission is preferably deducted at step 1038, the team members/players are notified of the game results at step 1040, and an opportunity for a rematch is extended at step 1042. These steps proceed as described above in connection with steps 636, 632, and 640. Preferably, a rematch includes the same team members.

Thus, in a simple game in which only two players compete against one another through a distributed network, then each will ante, say, $10 to create a pot of $20.00. The winner of that game is credited with the pot, less any commission owing to the host server 110. And, in a more complex game in which teams or multiple players compete against one another through a distributed network, each player again provides an ante in order to play, with the submitted antes comprising a pot which is credited to the winner(s) in accordance with the prevailing payout rules. In either the simple or complex game scenario, players are provided with a high level of trust because they interact with other real people, before, during and after the game in chat rooms created for them, and because, for some games, the skill levels of the other players has been filtered to match an opponent's skill level.

To better ensure that players have the same amount of time to answer questions, “onload (start timer)” commands or the like can be used to determine how much time has elapsed between the loading of the page and a response by the player. Moreover, the question can be presented as a graphic which is buffered and only displayed once fully downloaded, as understood by those of skill in the art. To thwart efforts to cheat, the filename of the graphic which includes the question can be assigned randomly. In this manner, differences in connection speed and download time are accommodated more fairly.

The amount of the commission to the host server is arbitrary. It can be about 1% to about 10% of the pot, and more preferably is about 2% to about 5% of the pot. Reduced commissions can be offered to frequent players.

As understood by those of skill in the art, the process flow in the context of an object-oriented environment such as the graphical interface presented on the World Wide Web, need not be executed in the order presented in a conventional flow diagram. Rather, process flows can be driven dynamically in response to user actions. Also, as understood by those of skill in the art, a client-side Active X component, JavaScript or equivalent can be used to test various forms described herein for completeness prior to their being posted to the host server 110, with suitable prompts given to the user to guide the user toward completing the form.

While the present invention has been described with respect to a particularly preferred embodiment, the invention is susceptible to implementation in other ways which are within the spirit of the invention which is defined in terms of the recitations of the appended claims and equivalents thereof.

I claim:

1. A method for enabling players to gamble directly with one another, comprising the steps of:
a) for each player, receiving at a host server a bet conveyed from a machine connected to the host server through a distributed network;
b) combining the received bets from a set of players into a pot;
c) commencing a hosted game among the set of players by prompting the players at their respective machines for inputs;
d) receiving the inputs at the host server;
e) selecting at least one winner of the hosted game from among the set of players based on the received inputs; and
f) allocating the pot of the hosted game to the at least one winner in accordance with prescribed rules.

2. The method as in claim 1, wherein there is one winner and wherein the allocating step comprises crediting said one winner with the pot.

3. The method as in claim 2, including the additional step, prior to the allocating step, of deducting a commission from the pot.

4. The method as in claim 1, wherein each bet received at the host server comprises an authorization to charge or credit a designated account of a respective player.

5. The method as in claim 1, wherein each of the players in the set of players has agreed to bet the same amount of money to participate in the hosted game.

6. The method as in claim 1, including the additional step of notifying the set of players in the hosted game of the at least one winner.

7. The method as in claim 6, wherein each bet received at the host server comprises an authorization to charge or credit a designated account of a respective player, and wherein the notifying step further includes notifying each player of any charges or credits to a respective designated account.

8. The method as in claim 1, including the additional step, after the allocating step, of prompting each player to play again against the other players in the set of players.

9. The method as in claim 8, including the additional steps of repeating steps (a) through (f).

10. The method as in claim 1, wherein the hosted game is a pick-a-number game and wherein the inputs received at the host server is at least one number from each player.

11. The method as in claim 10, including the additional step of generating a random or pseudorandom number at the host server, and wherein the selecting step comprises:
comparing the numbers provided by each player to number generated at the host server for a match, and
selecting as the at least one winner any player who input a matching number.

12. The method as in claim 11, wherein, in the event that two or more players input a matching number, steps (c) through (e) are repeated for each player that input the matching number prior to the allocating step.

13. The method as in claim 1 0, including the additional step of generating a random or pseudorandom number at the host server, and wherein the selecting step comprises:
calculating a difference between the number provided by each player and the number generated at the host server, and
selecting as the at least one winner the player whose calculated difference is a minimum.

14. The method as in claim 13, wherein the selected step excludes any player in the set of players that provided a number which is greater than the number generated by the host server.

15. The method as in claim 13, wherein the selecting step excludes any player in the set of players that provided a number which is less than the number generated by the host server.

16. The method as in claim 13, wherein a prescribed number of additional winners are selected in order of increasing calculated differences from said minimum calculated difference.

17. The method as in claim 1, wherein each player has a respective a list of buddies associated therewith, and wherein each player is apprized as to which, if any, of his or her associated buddies are presently connected to the host server.

18. The method as in claim 17, wherein one player can challenge a buddy from his or her buddy list to participate in the hosted game by having an electronic message conveyed to that buddy.

19. The method as in claim 18, wherein the electronic message is an instant message conveyed from said one player's machine to the machine of the challenged buddy.

20. The method as in claim 1, including the additional step of rating each player by skill level and wherein each of the players in the set of players differs in skill level by at most a prescribed amount.

21. The method as in claim 20, wherein each of the players in the set of players has the same skill level.

22. The method as in claim 20, wherein the rating step comprises utilizing information in a database concerning at least each player's prior performance in one or more hosted games.

23. The method as in claim 20, wherein the rating step comprises posting a series of questions to each player and gauging the correctness of the responses provided by each player.

24. The method as in claim 1, including the additional steps of:
permitting multiple potential players to chat in a chat room made available by the host server, and
enabling the potential players to select a hosted game in which to participate together,
whereby the players choose the members of the set of players for the hosted game.

25. The method as in claim 1, wherein the host server conveys to each player's machine a personal Web page which includes statistics concerning that player's performance.

26. A method for enabling teams of players to compete directly against each other for money, comprising the steps of:
a) establishing at least a first team and a second team, the teams including non-overlapping sets of players each of which is connected by a machine to a host server through a distributed network;
b) receiving at the host server an ante conveyed from each player's machine;
b) combining the antes from all of the players into a pot;
c) commencing a hosted game among the teams by prompting the players of each team at their respective machines for inputs;
d) receiving the inputs at the host server;
e) selecting at least one winning team from among the teams based on the received inputs; and
f) allocating the pot of the hosted game to the at least one winning team in accordance with prescribed rules.

27. The method as in claim 26, wherein the first input received from a player on a given team in response to a particular prompt is registered at the host server and wherein the selecting step is based upon the registered inputs.
